(19) United States
(12) Patent Application Publication
(10) Pub. No.: US 2025/0370668 A1
(43) Pub. Date: Dec. 4, 2025

(54) METHODS AND PRINTING SYSTEM FOR MANAGING PRINTING OPERATIONS DURING IDLE TIME

(71) Applicant: Kyocera Document Solutions Inc., Osaka (JP)

(72) Inventors: Jayant BHATT, Torrance, CA (US); Javier A. MORALES, Rochester, NY (US)

(73) Assignee: Kyocera Document Solutions Inc., Osaka (JP)

(21) Appl. No.: 18/676,269

(22) Filed: May 28, 2024

(51) Int. Cl. G06F 3/12

(52) U.S. Cl. CPC G06F 3/1217; G06F 3/1259; G06F 3/126

(57) ABSTRACT

A printing system includes a printing device that receives print jobs. The printing device includes a controller having a raster image processing (RIP) system that includes a RIP manager and at least one renderer. The RIP manager detects that the print engine of the printing device is idle. The RIP system renders various jobs using renderers during the idle time and stores the rendered pages in a storage for the RIP system. Once a storage threshold is reached, the RIP system allocates the renderers to render only complex pages within the print job and stores the rendered complex pages to a secondary storage. If a secondary job is active, then available renderers are allocated to rendering pages of the secondary job. Once printing resumes at the print engine, the RIP manager reallocates the rendering resources back to normal.

### FIELD OF THE INVENTION

The present invention relates to a printing system and associated methods to manage printing operations during idle time of the print engine by continuing to render pages.

### DESCRIPTION OF THE RELATED ART

Different situations arise where the print engine of a printing device is not printing pages. These situations can occur due to a variety of reasons, such as the print engine being offline or needing attention. These situations also demand human interaction, which can be an indeterminate amount of time. Thus, problems arise with large production printing operations when the print engine of the printing device sits idle waiting for the resolution of these situations.

### SUMMARY OF THE INVENTION

A method for managing printing operations is disclosed. The method includes detecting that a print engine in a printing device is not operating. A plurality of print jobs is not printing at the print engine. The method also includes processing a print job of the plurality of print jobs at a raster image processing (RIP) system corresponding to the printing device. The method also includes generating at least one rendered page for the print job by the RIP system. The method also includes storing the at least one rendered page in a first data storage accessible by a digital front end of the printing device. The method also includes determining that a storage threshold is reached for the first data storage. The method also includes storing the at least one rendered page in a second data storage accessible by the DFE.

A method for managing printing operations is disclosed. The method includes detecting that a print engine in a printing device is not operating. A plurality of print jobs is not printing at the print engine. The method also includes processing a print job of the plurality of print jobs at a raster image processing (RIP) system corresponding to the printing device. The method also includes generating at least one rendered page for the print job by the RIP system. The method also includes determining whether the at least one rendered page is a complex page. The method also includes storing the at least one rendered page at a first data storage accessible by a digital front end (DFE) of the printing device if the at least one rendered page is not the complex page. The method also includes storing the at least one rendered page at a second data storage accessible by the DFE of the printing device if the at least one rendered page is the complex page.

A printing device is disclosed. The printing device include a processor. The printing device also includes a memory coupled to the processor. The memory stores instructions that, when executed by the processor, configures the printing device to perform the operations of detecting that a print engine in a printing device is not operating. A plurality of print jobs is not printing at the print engine. The operations also include processing a print job of the plurality of print jobs at a raster image processing (RIP) system corresponding to the printing device. The operations also include generating at least one rendered page for the print job by the RIP system. The operations also include storing the at least one rendered page in a first data storage accessible by a digital front end (DFE) of the printing device.

A method for managing printing operations is disclosed. The method includes detecting that a print engine in a printing device is not operating. A plurality of print jobs is not printing at the print engine. The method also includes processing a print job of the plurality of print jobs at a raster image processing (RIP) system corresponding to a digital front end (DFE) of the printing device. The method also includes generating at least one rendered page for the print job by a first renderer of the RIP system. The method also includes allocating a second renderer of the RIP system to a secondary job at the printing device. The method also includes processing the secondary job with the second renderer of the RIP system.

A method for managing printing operations is disclosed. The method includes detecting that a print engine in a printing device is not operating. A plurality of print jobs is not printing at the print engine. The method also includes processing a print job of the plurality of print jobs at a raster image processing (RIP) system corresponding to a digital front end (DFE) of the printing device. The method also includes determining that a storage threshold for a first data storage configured to receive rendered pages from the RIP system is reached. The first data storage is accessible by the DFE of the printing device. The method also includes allocating a first renderer of the RIP system to process at least one page of the print job. The at least one page is a complex page. The method also includes allocating a second renderer of the RIP system to process a secondary job received at the DFE.

A printing system is disclosed. The printing system includes a processor. The printing system also includes a memory coupled to the processor. The memory stores instructions that, when executed on the processor, configures the printing system to perform the operations of detecting that a print engine in a printing device of the printing system is not operating. A plurality of print jobs is not printing at the print engine. The operations also include processing a print job of the plurality of print jobs at a raster image processing (RIP) system corresponding to a digital front end (DFE) of the printing device. The operations also include generating at least one rendered page for the print job by a first renderer of the RIP system. The operations also include allocating a second renderer of the RIP system to a secondary job at the printing device. The operations also include processing the secondary job with the second renderer of the RIP system.

### BRIEF DESCRIPTION OF THE DRAWINGS

Various other features and attendant advantages of the present invention will be more fully appreciated when considered in conjunction with the accompanying drawings.

FIG. 1 illustrates a printing system for managing jobs according to the disclosed embodiments.

FIG. 2 illustrates a block diagram of components of the printing device for use within the printing system according to the disclosed embodiments.

FIG. 3 illustrates a block diagram of a RIP system for use in processing a job in the printing system according to the disclosed embodiments.

FIG. 4 illustrates a block diagram of an example RIP used within the RIP system according to the disclosed embodiments.

FIG. 5 illustrates a block diagram of the RIP system for use in managing printing operations according to the disclosed embodiments.

FIG. 6 illustrates a flow diagram for managing printing operations during out of a normal rendering process according to the disclosed embodiments.

FIG. 7 illustrates a flow diagram for managing operations during print engine idle time according to the disclosed embodiments.

FIG. 8 illustrates a flow diagram for page complexity determination in the RIP system according to the disclosed embodiments.

FIG. 9 illustrates a block diagram of the components used for page complexity determination according to the disclosed embodiments.

FIG. 10 illustrates a flow diagram for managing operations at the printing device during print engine idle time according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments manage the idle time of the print engine to optimize performance during the idle time. It also manages performance for the future when the print engine resumes printing operations. Various strategies may be employed to ensure that optimal performance is maintained. The disclosed embodiments may include use cases for idle time optimization with a raster image processing (RIP) system.

For example, one use case may be when the print engine is offline. When a print engine is turned offline, the digital front end (DFE) of the printing device of the print engine may be in the middle of rendering a print job. The printing of pages is suspended but pages are still allowed to render within the RIP system. This feature renders complex pages in advance that might be encountered later in the job when the print engine resumes printing operations.

Another use case may be when the printing device requires attention. The print engine might need attention that does not require a reboot, such as an empty paper tray, a paper jam, a full output tray, and the like. If a job is in the middle of rendering, then the printing operations of this job is suspended. The RIP system, however, is still allowed to render, similar to the print engine offline use case disclosed above.

Another use case may be a parallel processing resource reconfiguration. Various kinds of jobs are processed by the DFE in parallel to actual print jobs. These jobs require rendering but do not require pages to be printed, such as process and hold jobs, ink estimation jobs, preview jobs, and the like. The disclosed embodiments divert resources from “print” jobs to the other kinds of secondary jobs that do not require actual printing.

When a RIP manager of the RIP system detects that a print engine is not accepting pages, it may stop sending rendered pages to the print engine. The rendering of pages, however, still continues to ensure that rendered pages are available when the print engine resumes printing operations. Because multiple jobs may be queued for printing, the idle time of the print engine may be used to render multiple pages of multiple jobs ahead of time. This feature ensures that the printing is not stalled when complex pages are encountered later when processing a job. The disclosed embodiments render all pages to a faster, but smaller, data storage until a storage threshold is reached. The digital front end then switches to a secondary larger storage. At this point, the RIP system may render only complex pages, as simple pages may be rendered at engine speed when the print engine resumes printing operations. These features ensure optimal print performance and storage optimization.

In addition, the digital front end processes many kinds of jobs that do not require printing. These jobs may be known as secondary jobs and are allowed less resources compared to the “print” jobs when the print engine is accepting pages. When the print engine is idle, however, the resources may be diverted to the secondary jobs to ensure performance optimization during idle time of the print engine.

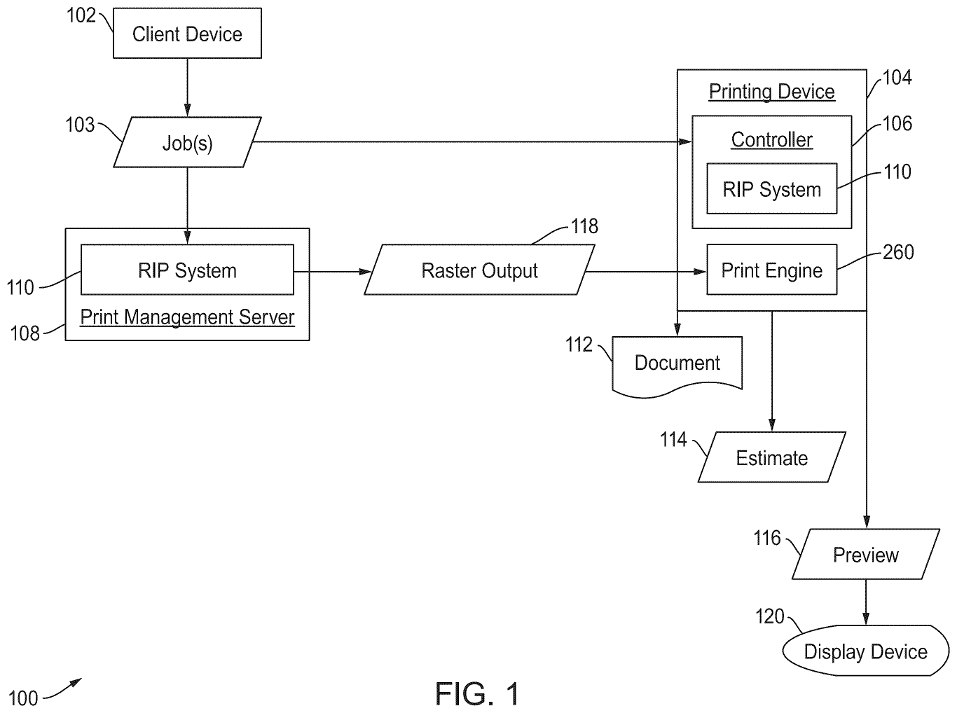

FIG. 1 depicts a printing system 100 for managing jobs using RIP system 110 according to the disclosed embodiments. Printing system 100 may be located in a print shop or other environment suitable for production printing operations. Printing system 100 includes one or more printing devices 104 that receive jobs 103 from one or more client terminals 102.

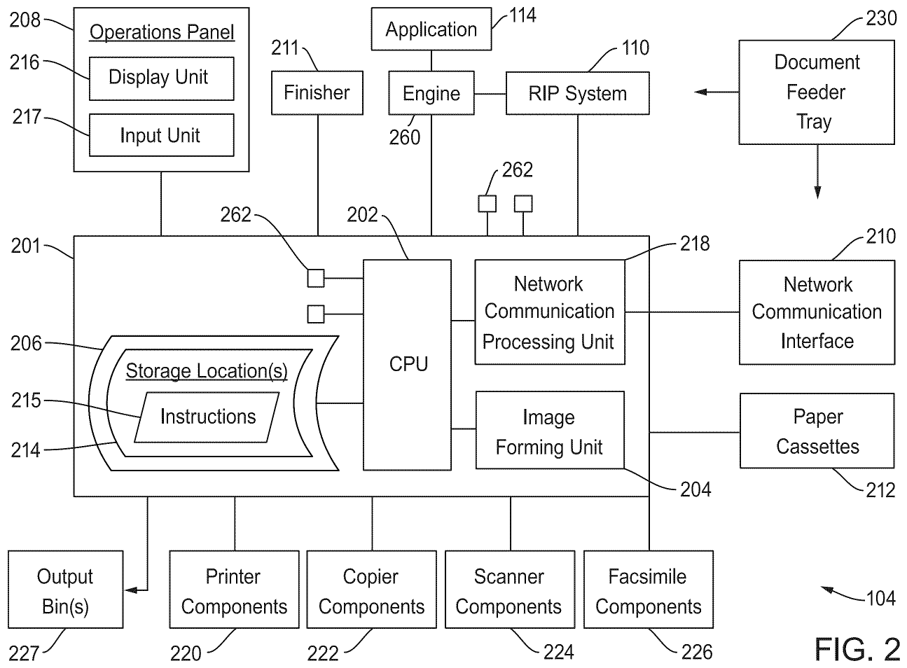

Printing device 104 receives jobs through printing system 100, such as job 103. In some embodiments, job 103 is a print job. After processing job 103, printing device 104 may print or produce document 112 in a paper or media specified by the print job. Printing device 104 is disclosed in greater detail in FIG. 2. Printing device 104 also includes a controller, or digital front end (DFE), 106, which facilitates processing job 103. Controller 106 also includes RIP system 110, which is disclosed in greater detail below.

For example, controller 106 may use RIP system 110 to convert bitmap images, vector graphics, fonts, and the like associated with pages in job 103 to bitmap/rasterized representations of the pages, such as C, M, Y, and K pixels. The sum of the values of pixels of a particular color in the rasterized pages may be proportional to the amount of consumables used by printing device 104 to print that color. RIP system 110 may rasterize pages of job 103 according to various image rasterization settings. For example, these image rasterization parameters may include calibration curves, paper definitions, ICC profiles, spot color definitions, TRCs, color conversion settings, colorant limits for ink or toner, rendering intent, K preservation, CGR level, max colorant densities, print margins, halftones, and the like.

Print engine 260 also is included with printing device 104. Printing device 104 may correspond to an industrial printing device capable of printing thousands of pages in an hour. Printing device 104 may be ink-based, toner-based, or both. Print engine 260 may include various parameters that can control the operation of printing device 104. For example, these settings may include printing device maintenance settings that control or effect head cleaning intervals, head clogging prevention intervals, and the like of printing device 104. Print engine 260 receives raster output from RIP system 110 in printing device 104 to print document 112 based on job 103.

Printing system 100 receive job 103 and may route it directly to printing device 104. Alternatively, printing system 100 may route job 103 to print management server 108. Print management server 108 may seek to offload processing of job 103 from controller 106 of printing device 104. This feature may be desirable if controller 106 does not have the processing capacity to handle jobs 103 in a production printing environment. Thus, print management server 108 also may include RIP system 110 that can provide raster output 118 directly to print engine 260 of printing device 104. These embodiments allow controller 106 to offload processing in order to handle other operations. Further, updates to RIP system 110 may occur at print management server 108 prior to any updates to RIP system 110 in printing device 104.

Job 103 is not always a print job that produces document 112. In some embodiments, job 103 may be an estimation job or a preview job. RIP system 110 determines which type of job is job 103 and configures itself accordingly. For an estimation job, RIP system 110 configures RIPs to process job 103 without impacting print processing within controller 106. The estimation RIPs process job 103 to provide an ink or toner estimate 114. Estimate 114 may be provided to an operator without engaging print engine 260.

For a preview job, RIP system 110 configures RIPs to process job 103 to quickly generate a lower resolution output as preview 116. Preview 116 may be a lower resolution output as compared to document 112 and estimate 114. Preview 116 is provided to the operator to review. Preview 116 may be provided to display device 120 for the operator to review and interact with using an interface. Display device 120 may be a separate device from client device 102 and printing device 104. In other embodiments, display device 120 may be incorporated within client device 102 or printing device 104.

RIP system 110 may be a smart system that enables optimal processing by using page complexity determination to handle a variety of jobs 103. Different jobs received at printing device 104 or print management server 108 result in different output, such as document 112, estimate 114, or preview 116. The RIP instances within RIP system 110 are configured according to the type of job 103 is received.

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within printing system 100. As disclosed above, printing device 104 may send and receive data from client device 102, print management server 108, if a separate device, and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto printing device 104. The information for printing these papers may be captured in a paper catalog stored at controller 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from print management server 108. Display unit 216 may act as display device 120 for displaying preview 116 after it is generated by RIP system 110.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. RIP system 100 that interprets the page description languages (PDLs) would transmit and send instructions down to the lower-level engine 260 for actual rendering of an image and application of the ink onto paper during operations on printing device 104. RIP system 110 may be located in DFE 106, as disclosed above. Alternatively, RIP system 110 may be located on print management server 108 and directly communicates with print engine 260.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device.

Memory unit 206 may store the history of failure events and occurred errors with a timestamp of each error. Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from client device 102 and print management server 108 as well as other printing devices within printing system 100.

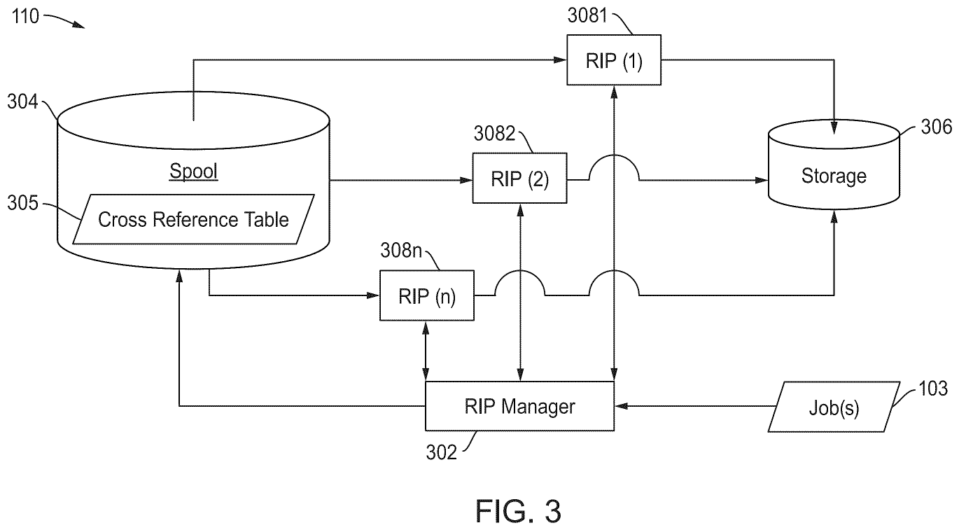

FIG. 3 depicts a block diagram of RIP system 110 for use in processing job 103 in printing system 100 according to the disclosed embodiments. As disclosed above, RIP system 110 may be located in controller 106 of printing device 104. It also may be located on print management server 108 such that it communicates directly with print engine 260 of printing device 104.

RIP system 100 include RIP manager 302 and RIP instances RIP 3081, RIP 3082, and RIP 308n. A RIP instance may be a RIP configured by RIP manager 302 to process job 103. A RIP instance may be a standard RIP, a high performance RIP, a very high performance RIP, a preview RIP, an estimation RIP, or a failover RIP. All RIP instances and RIP manager 302 operate in parallel to each other.

RIP manager 302 performs a variety of operations. It may contain multiple subunits that operate in parallel to perform the variety of operations, like spooling job 103, managing job 103, managing pages or segments of job 103, managing RIP instances 3081, 3082, and 308n, managing drives, determining the PDL type of job 103, distributing pages of segments of job 103 to the RIP instances, serializing pages or segments of job 103, sending notifications within printing device 104 or print management server 108.

RIP manager 302 may receive job 103 through printing system 100. Job 103 may be received from client device 102 via internet protocols within printing system 100. Job 103 may be spooled by RIP manager 302 and stored in spool drive 304. Spool drive 304 may be a configurable drive. RIP manager 302 determines the PDL type of job 103. It then creates a cross reference table 305 in spool drive 304, which acts as a shared memory with RIP instances 3081, 3082, and 308n. RIP manager 302 also may create print ticket information in spool drive 304.

RIP manager 302 analyzes job 103 to determine which type of job it is. It uses this information to determine the number of RIPs and type of RIPs to be used in processing job 103. These features are disclosed in greater detail below. Depending on the type of job, RIP manager 302 configures RIP instances 3081, 3082, and 308n. A configuration operation may create a RIP having a certain number of renderers. For example, RIP instance 3081 may be a standard RIP having a normal number of renderers, such as 4. RIP instance 3082 may be a high performance RIP that has a higher number of renders, such as 6. RIP manager 302 configures the RIP instances accordingly to process job 103.

RIP manager 302 then distributes pages or segments of job 103 to RIP instances 3081, 3082, and 308n. Job 103 may be a print job that is split into segments or pages for parallel processing. As RIP instance 3082 is a high performance RIP, then it may receive specific pages or segments of job 103. Pages may refer to one or more pages of job 103. Segments of job 103 also may refer to a number of pages or a block of data within job 103. The pages or segments are distributed by front end 302 using inter-process communication.

RIP instances 3081, 3082, and 308n may read cross reference table 305 along with print ticket information and the spooled data for job 103. Each RIP instance then processes the page or segment that it is instructed to by RIP manager 302. The RIP instance may check cross reference table 305 to obtain any instructions in the print ticket information and the data for the page or segment in spool drive 304. RIP instances 3081, 3082, and 308n then parse the data for the page or segment to create metadata from the drawing commands.

The RIP instances render the metadata to storage 306. Storage 306 may store the rendered pages for a print job of job 103. The rendered pages may be stored according to a specific image format, such as the KYOCERA™ Image Format (KIF). The stored pages may then be provided to print engine 260 to print document 112. For jobs 103 that do not require rendered pages, such as previews and estimates, the data generated by the RIP instances may be provided back to front end 302 for further operations.

RIP system 110 provides advantages over conventional RIP systems. RIP manager 302 may control the number of renderers per RIP. It may increase the number to process a page or segment faster. It also may increase the amount of memory allocated to the RIP as faster processing consumes more memory. If processing is to be slower, such as for estimate 114 or preview 116, then the configured RIP should consume less memory. RIP manager 302 manages these requirements through dynamic configuration of the RIPs based on the parameter of job 103.

In some instances, RIP manager 302 may determine that job 103 is not able to be split into pages or segments for parallel processing. Thus, it may configure a RIP instance, such as RIP instance 308n, into a very high performance RIP. The very high performance RIP uses more renderers than the high performance RIP. For example, RIP instances 308n may be configured to use 8 renderers. This feature increases the processing speed of RIP instance 308n. Front end 302 may still use RIP instances 3081 and 3082 for parallel processing on one job 103 while using RIP instance 308n for processing another job 103 that is not able to be broken into pages or segments.

RIP system 110 provides features available due to the parallel processing using dynamically configured RIP instances. RIP system 110 may configure a high performance RIP to improve the first page out time. It also may use differently configured RIPs for different purposes, such a preview RIPs, estimation RIPs, and failover RIPs. RIP system 110 also may configure very high performance RIPs for jobs that cannot be processed in a page or segment parallel manner.

RIP system 110 also provides the ability to change the number of renderers per RIP. RIP system 110 also changes the number of RIP instances based on its workload, which includes shutting down certain types of RIPs in order to launch other types of RIPs. RIP system 100 also processes different kinds of jobs in RIPs with different configurations. RIP system 110 also uses different RIPs with different configurations for different purposes. It configures RIP instances with different imaging pipelines. RIP system 110 also retries failed jobs or job pages in a differently configured RIP instance.

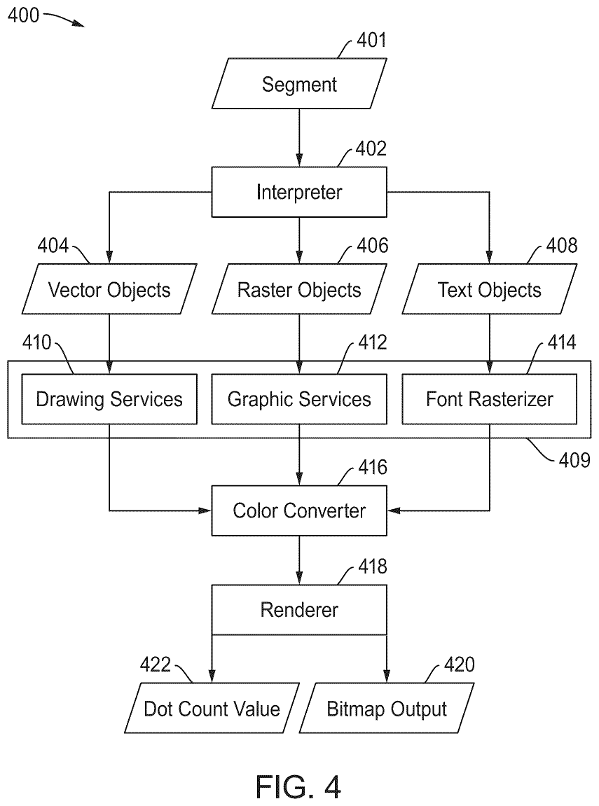

FIG. 4 depicts a block diagram of an example RIP 400 used within RIP system 110 according to the disclosed embodiments. RIP 400 may represent a configuration for RIP instances 3081, 3082, or 308n. RIP 400 may represent the hardware and software configuration used to determine what value each pixel or spot of output should possess, driven by commands from a page description language (PDL). Computer-generated output may be composed of very small spots. RIP 400 converts a vector-based image, or a stored image, into a series of mathematical formulas that describe lines and curves into a pattern of spots needed to generate the output, or raster image. Interpreter 402 converts a job file into a display list, which is then converted into a bitmap output 418 describing a page of the document.

RIP 400 converts text and image data from different file formats including PDF, TIFF, or JPEG into a format that printing device 104 can understand. The process of raster image processing a page implements several steps to be performed, regardless whether the page is submitted as PostScript, PDF, or any other page description language (PDL). In short, RIP 400 may provide interpretation, rasterization, and screening.

Segment 401 may be a job file associated with job 103. Segment 401 may be provided to RIP 400 to convert its code into raster or bitmap code. As disclosed above, front end 302 receives job 103. Front end 302 may split job 103 into segments for parallel processing by the RIP instances. Preferably, segment 401 is a page the document in job 103. RIPs process pages in a parallel manner within RIP system 100. RIP 400 is one of the RIP instances. In other embodiments, segment 401 may be several pages, a graphic design, or other portion of job 103.

Segment 401 is received at interpreter 402, which interprets the commands in the code to redraw the object and elements of a page as vector objects 404, raster objects 406, and text objects 408. Interpreter 402 parses specific PDLs into drawing commands. The PDL of segment 401 is read and decoded into graphical elements to be placed on a sheet. Each element may be an image, a character of text, a fill, stroke, and the like or listed in vector objects 404, raster objects 406, and text objects 408.

Drawing unit 409 receives vector objects 404, raster objects 406, and text objects 408 to convert the drawing commands into metadata that can be provided to renderer 418. Thus, drawing unit 409 converts vector objects 404 into drawing services 410. It also converts raster objects 406 into graphic services 412. It also converts text objects into font rasterizer 414.

RIP 400 also may implement color converter 416. Color converter 416 may implement color conversion operations for the metadata generated by drawing unit 409. Color converter 416 provides color management and calibration. These actions may be applied during interpretation or rendering, depending on configuration and job content. Color printing resources may be accessed to provide the color management.

Renderer 418 processes the metadata from drawing unit 409 to convert every graphical element into the appropriate pattern of pixels to form the output raster. The resolution independent vector objects 404 as drawing services 410 are converted into pixels. Screening takes the raster image of pixels to form individually screened cyan, magenta, yellow, and black separations. These are halftone dots in the form of a bitmap output 420 consisting of commands that can be understood by print engine 260.

The disclosed embodiments also may determine dot count value 422 from the rendered image provided by renderer 418. Dot count values may be adjusted based on screening and based on settings at printing device 104. Dot count value 422 may be reported to determine estimate 114 for an estimation job, as disclosed below.

The rendered bitmap output 420 may be stored in storage 306 to be sent to print engine 260 when all the pages or segments of job 103 are processed. RIP 400 shows one path for rendering and providing output. Preferably, RIP 400 multiple rendering paths that use multiple renderers. The disclosed embodiments may use a renderer 418 for each channel in RIP 400, such as one each for cyan, magenta, yellow, and black. The number of renderers 418 may be configured by front end 302 depending on job 103. Each renderer 418 requires memory and processing resources. A high number of renderers 418 in RIP 400 will consume more memory but run faster. A lower number of renderers 418 in RIP 400 will consume less memory but run slower.

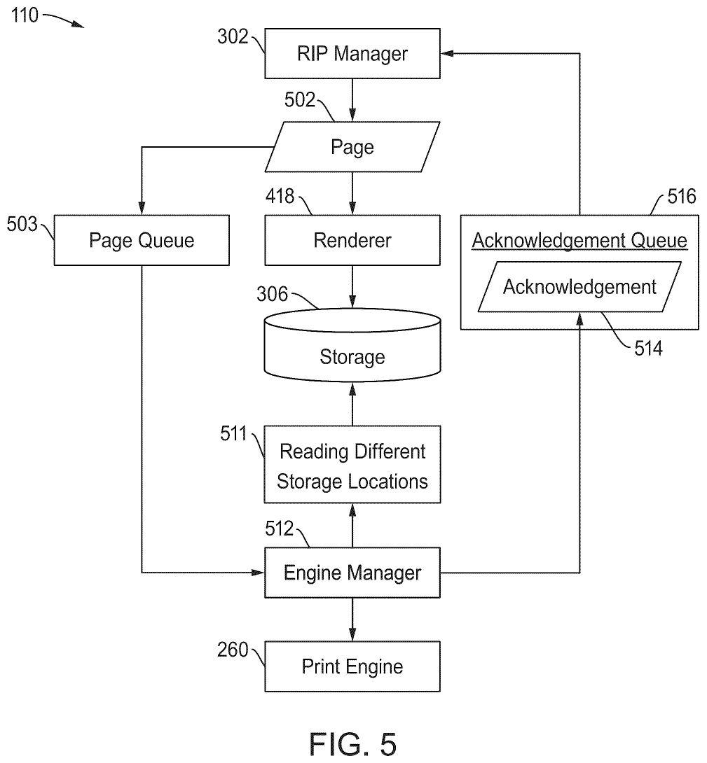

FIG. 5 depicts another block diagram of a RIP system 110 for use in managing printing operations according to the disclosed embodiments. FIG. 5 may disclose additional components of RIP system 110. For example, RIP system 110 includes RIP manager 302 and renderer 418, disclosed above. Further, RIP system 110 may include an engine manager 512, disclosed in greater detail below. RIP manager 302 may consider one or more pages 502 for print job 103. RIP manager 302 may determine if page 502 has already been rendered. If so, then the page data for the rendered page is placed into page queue 503. If page 502 has not been rendered, then it is passed to renderer 418.

Renderer 418 renders each page of a print job, as disclosed above. Renderer 418 then writes the rendered page to storage 306. Additional storages may be used if storage 306 becomes too full. In some embodiments, the rendered pages may be saved to specific storage locations within storage 306. These locations are provided to RIP manager 302 from renderer 418. RIP manager 302 provides these locations to engine manager 512 along with information regarding those pages within page queue 503. Engine manager 512 reads different storage locations based on the page data from page queue 503 according to operation 511 to retrieve the whole document and provide it to print engine 260 for printing. Engine manager 512 may be the interface between RIP system 110 and print engine 260. Pages may be printed in order as they are retrieved from their respective storage locations and provided to print engine 260.

After printing, the rendered page data is deleted from storage 306. Print manager 512 also may send an acknowledgement 514 to RIP manager 302, which then may delete the rendered page data from storage 306. Alternatively, engine manager 512 may delete the rendered page data from storage 306. In some embodiments, RIP system 110 may include an acknowledgement queue 516 to holds acknowledgement 514 to provide to RIP manager 302.

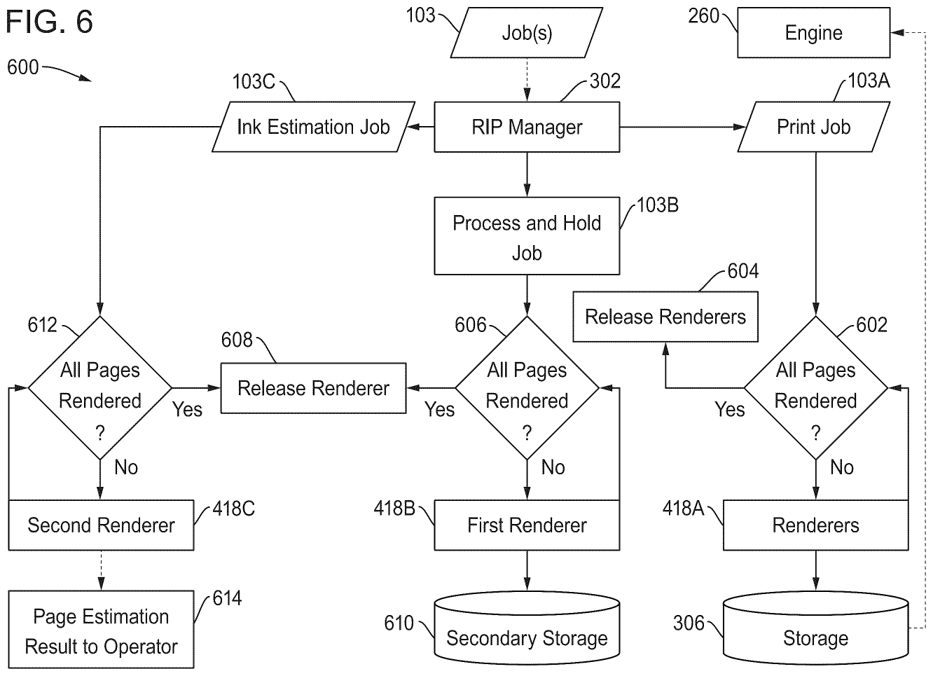

FIG. 6 depicts a flow diagram 600 for managing printing operations during out of a normal rendering process according to the disclosed embodiments. Flow diagram 600 may refer to FIGS. 1-5 for illustrative purposes. Flow diagram 600, however, is not limited to the embodiments disclosed by FIGS. 1-5. In flow diagram 600, many jobs are processed in parallel and many pages of a “print” job are processed in parallel.

Various jobs 103 are provided to RIP manager 302 of RIP system 110. RIP manager 302 may determine what “type” of job is applicable for each of the various print jobs. For example, one job may be a print job 103A. Print job 103A may be assigned to one or more renderers 418A for rendering pages to be printed by print engine 260. Renderers 418A may operate like renderer 418 disclosed above. Operation 602 executes by determining whether all pages in print job 103A have been rendered. If yes, then operation 604 executes by releasing the allocated renderers 418A within RIP system 110. RIP manager 302 may assign allocated renderers 418A to the next job of jobs 103.

If operation 602 is no, then renderers 418A render the next page of the pages of print job 103A. After rendering the page, flow diagram 600 returns to operation 602. Once this page is rendered, it is stored in storage 306, as disclosed above. Print engine 260 prints the rendered page from storage 306. As disclosed above, in some embodiments, engine manager 512 retrieves the rendered page from storage 306.

Secondary jobs also may be processed within RIP system 110. As disclosed above, secondary jobs are those that do not result in printed pages yet still use resources within controller 106. One secondary job may be process and hold job 103B. A process and hold job may be one that is processed within RIP system 110 but not immediately printed. The printing operations using print engine 260 may occur later. Thus, the pages from process and hold job 103B may be stored in secondary storage 610. Secondary storage 610 may be a larger storage device but may be slower to use than storage 306. For example, secondary storage 610 may be a hard-disk or storage drive accessible by RIP system 110 and controller 106. Process and hold job 103B may be processed using a first renderer 418B. RIP manager 302 preferably only assigns a single renderer to process and hold job 103B.

Operation 606 executes by determining whether all pages of process and hold job 103B have been rendered. If yes, then operation 608 executes by releasing first renderer 418B. RIP manager 302 may use renderer 418B for a subsequent job 103. If operation 606 is no, then first renderer 418B renders the page and returns to operation 606. The rendered page is stored in secondary storage 610.

Another secondary job may be an ink estimation job 103C. An ink estimate job 103C may be used to provide an ink estimate for a subsequent print job, as disclosed above. Similar types of jobs include a preview job. Ink estimation job 103C may use second renderer 418C to process each page of ink estimation job 103C. Operation 612 executes by determining whether all pages of ink estimation job 103C have been rendered. If yes, then operation 608 is executed as disclosed above. RIP manager 302 may use renderer 418C for a subsequent job 103. If operation 612 is no, then second renderer 418C renders the page and returns to operation 612. The rendered page is used in an ink estimation process in operation 614 to provide the estimation result to the operator.

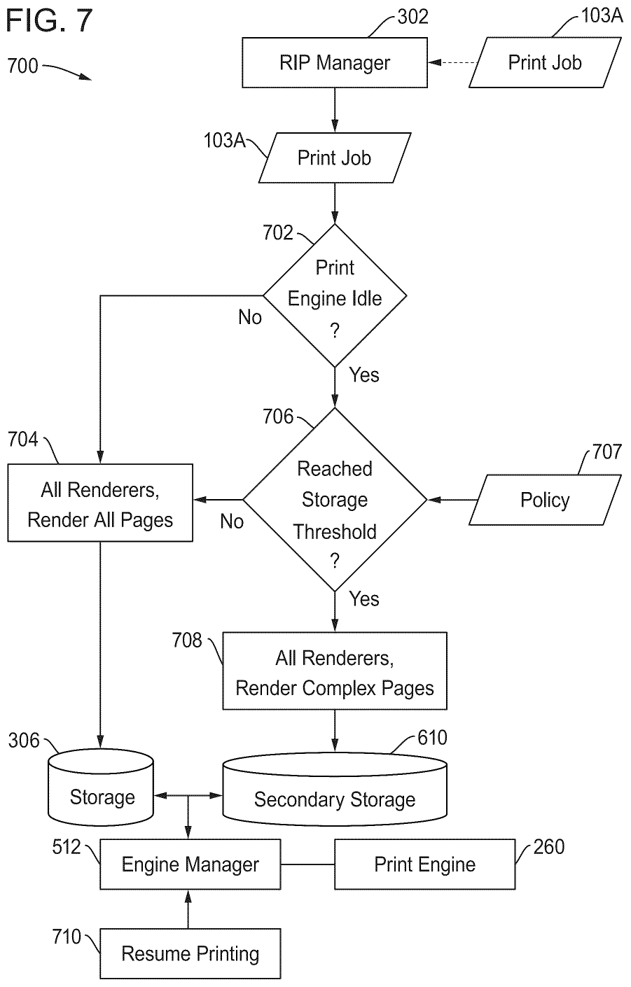

FIG. 7 depicts a flow diagram 700 for managing printing operations during print engine idle time according to the disclosed embodiments. Flow diagram 700 may refer to FIGS. 1-6 for illustrative purposes. Flow diagram 700, however, is not limited to the embodiments disclosed by FIGS. 1-6.

The disclosed embodiments may include the use case when print engine 260 is not accepting pages. Controller 106 only may have multiple print jobs as various jobs 103 and no other secondary jobs. The disclosed embodiments provide RIP manager 302 and controller 106 the ability to use all its resources to render the pages of multiple print jobs 103A. Once a threshold is reached in storage 306, RIP manager 302 switches to a secondary storage 610. RIP system 110 only renders complex pages.

In some embodiments, storage 306 may be referred to as a fast storage as data may be read from the storage in a manner to meet the speed of print engine 260. Printing operations will proceed seamlessly when reading rendered pages, such as page 502 disclosed above, from storage 306. Secondary storage 610 may be referred to as big or slow storage in that data read from this storage occurs at a speed slower than print engine 260 may print pages. Large amounts of data for a rendered page, however, may be stored in secondary storage 610 and read in a manner faster than re-rendering the page in later operations. Thus, the disclosed embodiments will render and store complex pages while discarding simple pages that may be rendered quickly once printing resumes.

Referring to flow diagram 700, RIP manager 302 receives print jobs 103A. It may select print job 103A to process and render. Operation 702 executes by determining whether print engine 260 is idle. If no, then flow diagram 700 proceeds to operation 704. Operation 704 executes by rendering all pages of print job 103 using all available renderers, such as renderers 418A, 418B, and 418C. The rendered pages are stored in storage 306 until retrieved by engine manager 512 to print using print engine 260.

If operation 702 is yes, then print engine 260 is idle and not printing. Flow diagram 700 proceeds to operation 706, which determines whether a storage threshold is reached for storage 306. For example, print engine 260 may be idle for a period of time that results in storage 306 becoming full with rendered jobs. Further rendered pages may not be stored at storage 306 once the threshold is reached. For example, storage 306 may have a capacity of 100 MB. The storage threshold may be 80 MB, or 80% of the storage capacity for storage 306. This threshold may be set by a policy 707 accessible by RIP manager 302. Policy 707 may be stored at printing device 104.

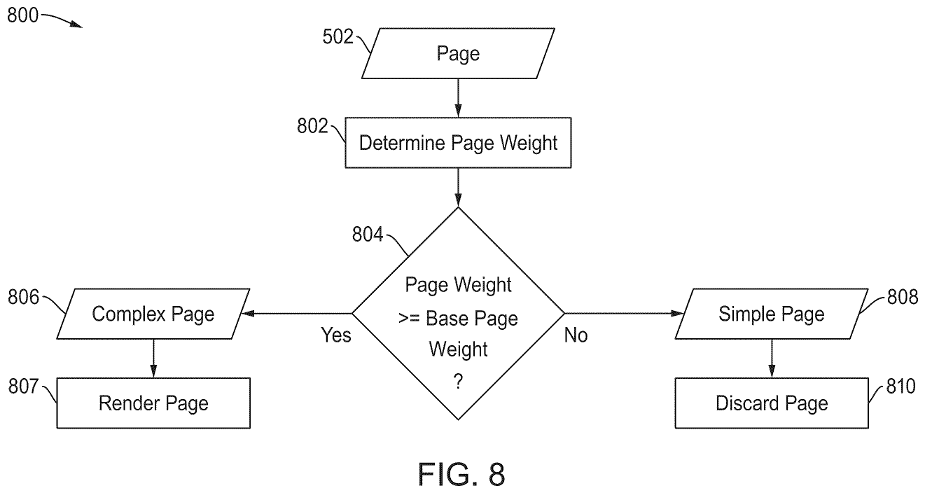

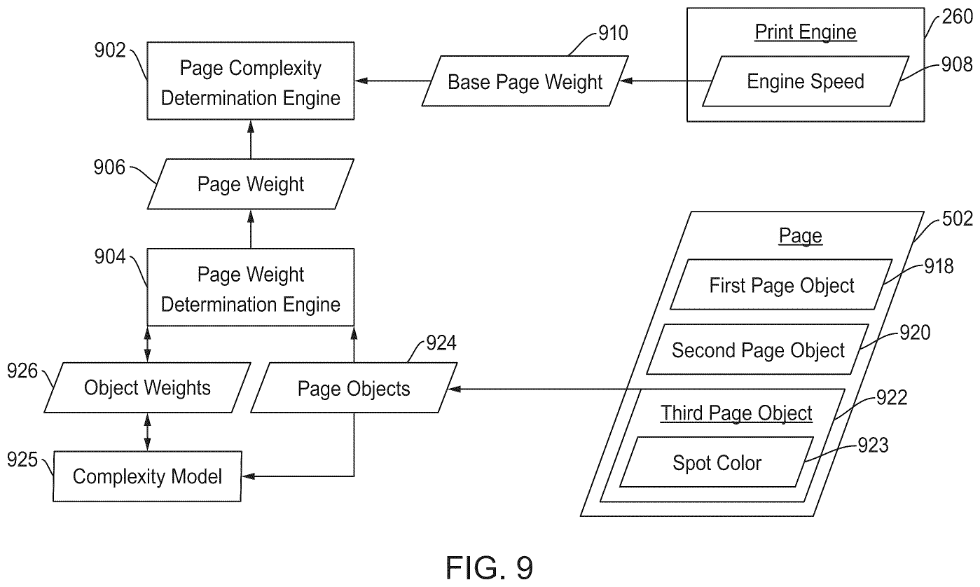

If operation 706 is no, then flow diagram 700 proceeds to operation 704, as disclosed above. Print job 103A is rendered by renderers 418A, 418B, and 418C and stored in storage 306. If operation 706 is yes, then operation 708 executes by using all renderers in RIP system 110 to render only complex pages within print job 103A. Thus, operation 708 also determines whether each page of print job 103A is a complex page or a simple page. This determination is disclosed in greater detail by FIGS. 8 and 9, disclosed below.

According to the disclosed embodiments, a complex page may be a page in a document that is rendered slower than the engine speed of print engine 260. Engine speed refers to the printing speed of print engine 260 after it receives a rendered page from engine manager 512.

A non-complex page may be known as a simple page. The rendering of simple pages may occur at faster pace than the engine speed of print engine 260. Rendered simple pages may fill up the limited storage space, or space complexity of storage 306, so that it may be better to defer rendering of the page when printing operations resume. A rendering process for a simple page may be performed fairly quickly without tying up resources of RIP system 110.

FIG. 8 depicts a flow diagram 800 for page complexity determination in RIP system 110 according to the disclosed embodiments. Flow diagram 800 may refer to FIGS. 1-7 for illustrative purposes. Flow diagram 800, however, may not be limited to the embodiments disclosed by FIGS. 1-7. Flow diagram 800 may be implemented in RIP system 110. For example, flow diagram 800 may be implemented by RIP manager 302 or renderer 418. In other embodiments, flow diagram 800 may be implemented elsewhere within printing system 100, such as controller 106.

Page 502 is received at RIP system 110 having renderers 418A, 418B, and 418C. Page 502 may be part of print job 103A. According to the disclosed embodiments, it is determined that the storage location for rendered pages of the job is not available or is limited so that the entire data set for the rendered pages cannot be stored. The disclosed embodiments determine if page 502 is complex. Operation 802 executes by determining a page weight for page 502. This process is disclosed in greater detail below and may be based on a set of rules and a weighted formula. Operation 804 executes by determining whether the page weight is greater than or equal to a base page weight. The base page weight is disclosed in greater detail below and is determined based on the engine speed of print engine 260. Thus, determining whether a page is complex relates to whether the page can be rendered “at speed” during printing operations.

If operation 804 is yes, then page 502 is marked as a complex page in operation 806. Operation 807 executes by rendering the page using all renderers, in conjunction with operation 708 of flow diagram 700. If operation 804 is no, then page 502 is marked as a simple page in operation 808. Operation 810 executes by discarding the page from being rendered using RIP system 110. The simple page may be re-rendered using the out of sequence rendering process disclosed above.

FIG. 9 depicts a block diagram of the components used for page complexity determination according to the disclosed embodiments. As disclosed above, base page weight 910 and page weight 906 are determined to be used in deciding whether page 502 is complex or simple. Both of these values are calculated using information available from printing device 104 and objects within page 502. These features are disclosed in greater detail below.

Base page weight 910 relates to engine speed 908 of print engine 260 of printing device 104. Engine speed 908 may refer to the pages or sheet per minute that printing engine 260 can process, or put ink to paper. This speed may refer to an average speed for a number of previous print jobs, or to the speed to print a page having no objects, such as one with only text. The disclosed embodiments may assign a weight, or value, to engine speed 908.

For example, print engine 260 may have an engine speed 908 of 150 PPM. This value may be based off previous print jobs and their engine speed to print pages of those jobs, regardless of the content on those pages. Alternatively, the disclosed embodiments may take the engine speed of printing certain types of pages, such as text only, pages with objects, pages with color printing, and the like. Using this example, base page weight 910 for engine speed 908 of 150 PPM may be 10.0.

For determining page weight 906, a page weight determination engine 904 may be implemented within one or more renderers 418A, 418B, and 418C of a RIP within RIP system 110. Page weight determination engine 904 also may be implemented elsewhere in controller 106, print management server 108, or RIP system 110. Page weight determination engine 904 may take into account page objects 924 from page 502 and object weights 926. These features are disclosed separately below.

Page objects 924 are objects, such as images, graphics, text, and the like, within page 502. For example, page 502 may include first page object 918, second page object 920, and third page object 922. Third page object 922 may include a spot color 923 that is required to print the third page object accurately. As disclosed above, an object may have a type, such as vector, text, or image. Objects may be further classified into operators, such as form, shading, group, Type 3 characters, pattern, font, color space, spot color, and the like. For example, first page object 918 may be a vector object having shading as an operator, second page object 920 may be a text object having a specific font and several Type 3 characters as operators, and third page object 922 may be an image object having spot color 923 as an operator.

The disclosed embodiments may compile the page objects and their operators into page objects 924 for page 502. Page objects 924 are provided to page weight determination engine 904. Page weight determination engine 904 may use one or more weighted formulas to determine the weights for page objects 924. The weighted formulas may rely on object weights 926 provide from complexity model 925. The disclosed embodiments gather statistics and generates complexity model 925 based on these determinations. Complexity model 925 is based on various components of a page, such as the type of objects disclosed above, or vector, text, or image. The objects in complexity model 925 also may be further classified into operators.

When page weight determination engine 904 receives page objects 924 of page 502, it may retrieve object weights from complexity model 925. Alternatively, page objects 924 may be provided to complexity model 925, which then provides page object 924 along with object weights 926 to page weight determination engine 904. First page object 918 may be compared to a similar page object in complexity model 925 to obtain a weight for the first page object. Second page object 920 may compared to a similar page object in complexity model 925 to obtain a weight for the second page object. Third page object 922 may be compared to a similar page object in complexity model 925 to obtain a weight for the third page object. In some embodiments, the object weights for first page object 918, second page object 920, and third page object 922 may be added together to determine page weight 906.

Page complexity determination engine 904 applies the rule that a page is marked complex if page weight 1006 exceeds base page weight 910. If page weight 906 exceeds base page weight 910, then page 502 is marked complex. If page weight 906 is equal or less than base page weight 910, then page 502 is marked as simple. Referring to the embodiments disclosed above, a complex page is stored in secondary storage 610 after being rendered while a simple page may be discarded.

Referring back to flow diagrams 700 and 800, if operation 804 determines the page is a simple page, then operation 810 executes by discarding the page from rendering operations in operation 708. Engine manager 512 will need to instruct RIP manager 302 to render the page when it is to be printed with a subsequent copy of print job 103A.

If operation 804 determines the page is a complex page, then operations 807 renders the page using all renderers of RIP system 110. The rendered page is stored in secondary storage 610. Engine manager 512 may inform RIP manager 302 of the stored location within secondary storage 610 of the rendered complex page.

At some point, operation 710 will execute by resuming printing operations at print engine 260. The idle time processing will cease and operations return to those disclosed in flow diagram 600. Engine manager 512 and RIP manager 302 will return to normal operations. Engine manager 512 may retrieve rendered pages from storage 306 and secondary storage 610 to provide to print engine 260 for printing. RIP manager 302 may instruct where to retrieve rendered pages. For pages that were discarded, RIP manager 302 will assign renderers to render the simple pages while instructing engine manager 512 to retrieve the complex pages from secondary storage 610 to provide to print engine 260.

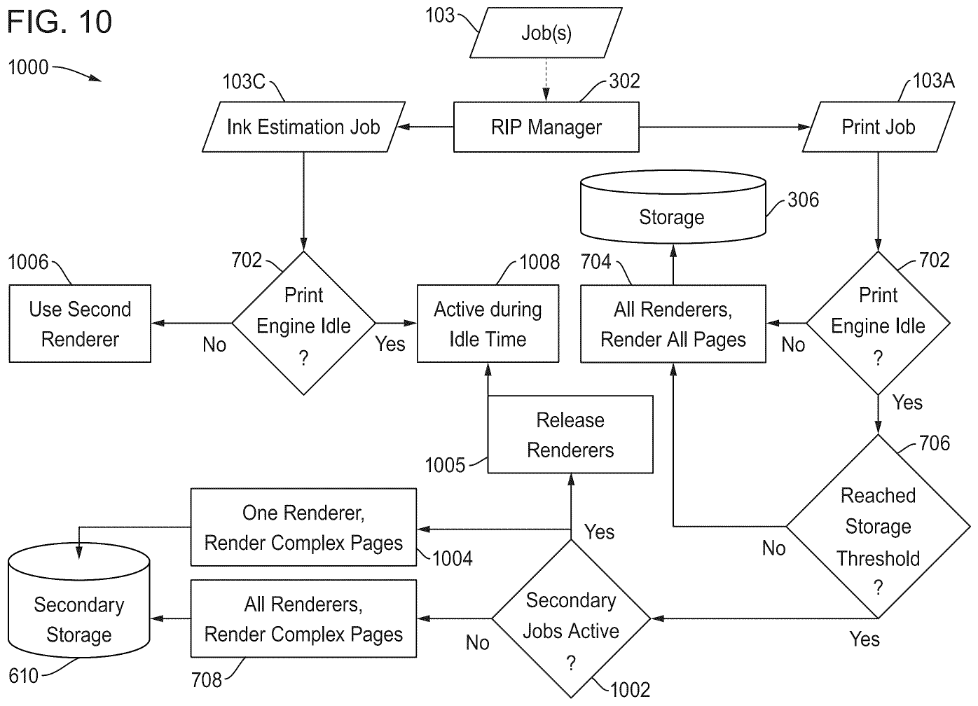

FIG. 10 depicts a flow diagram 1000 for managing operations at printing device 104 during an idle time for print engine 260 according to the disclosed embodiments. Flow diagram 1000 may refer to FIGS. 1-9 for illustrative purposes. Flow diagram 1000, however, is not limited to the embodiments disclosed by FIGS. 1-9.

Flow diagram 1000 may disclose the use case when print engine 260 is not accepting pages from RIP system 110. RIP system 110 may be handling multiple types of jobs, such as print jobs and secondary jobs. For example, RIP system 110 may be handling print jobs 103A and ink estimation jobs 103C. Referring to flow diagram 600, ink estimation jobs 103C are allocated less resources when print engine 260 is accepting pages. For example, second renderer 418C may be allocated to render the pages of ink estimation job 103C while a plurality of renderers 418A are allocated to print job 103A.

When print engine 260 is idle, however, some of the resources may be reallocated from print job 103A and distributed to ink estimate job 103C. RIP manager 302 may relinquish renderers to ink estimation jobs 103C to provide service to those secondary jobs that do not result in any printed pages. Secondary jobs may be processed to meet the requests from operators for the results of such jobs.

Referring to flow diagram 1000, various jobs 103 are received at printing device 104 and controller 106. Controller 106 provides various jobs 103 to RIP system 110. RIP manager 302 receives each job and determines what type of job. The type of job impacts how many resources, or renderers, will be allocated to processing the job. If the job is a print job 103A, then operation 702 executes by determining if print engine 260 is idle. Operation 702 is disclosed above.

If operation 702 is no, then operation 704 executes by using all available renderers to render all the pages of print job 103A. The rendered pages are stored in storage 306 until retrieval for printing by print engine 260. If operation is yes, then print engine 260 is idle. Flow diagram 1000 proceeds to operation 706, which executes by determining whether the storage threshold for storage 306 is reached. Operation 706 is disclosed in greater detail above. If operation 706 is no, then flow diagram 1000 proceeds to operation 704.

If operation 706 is yes, then flow diagram 1000 proceeds to operation 1002. Operation 1002 executes by determining if secondary jobs are active. Secondary jobs may be active when one is received at RIP manager 302 for processing and rendering. For example, referring back to ink estimation job 103C, operation 702 executes by determining whether print engine 260 is idle. If no, then operation 1006 executes by using second renderer 418C to render the pages of ink estimation job 103C, as disclosed in flow diagram 600.

If operation 702 is yes, then, using operation 1002, ink estimation job 103C is active along with print job 103A during the idle time. Thus, if operation 1002 is no, then operation 708 is executed by rendering complex pages of print job 103A with all available renderers, such as renderers 418A, 418B, and 418C. The determination of complex pages is disclosed in greater detail above by flow diagrams 800 and 900. Simple pages may be discarded. Rendered complex pages are stored at secondary storage 610.

If operation 1002 is yes, then flow diagram 1000 proceeds to operations 1004 and 1005. Operation 1004 executes by allocating one renderer to render complex pages of print job 103A. For example, one renderer 418A may be allocated to render one or more complex pages of print job 103A. Operation 1005 also executes by releasing the remaining renderers 418A for reallocation by RIP manager 302. Flow diagram 1000 proceeds to operation 1008 to allocate second renderer 418C and released renderers 418A to render pages for ink estimation job 103C. Further, if operation 702 is yes, then flow diagram 1000 proceeds to operation 1008.

Operation 1008 renders pages for ink estimation job 103C using all available renderers within RIP system 110 except for the single renderer allocated to render complex pages of print job 103A. Thus, additional resources of RIP system are provided to render secondary jobs when print engine 260 is idle. This feature uses RIP system resources in a better manner and to optimize getting jobs completed while print engine 260 is idle. When print engine 260 restarts printing pages, RIP manager 302 will reallocate the renderers back to normal processing, such as disclosed in FIG. 6.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing printing operations, the method comprising:
detecting that a print engine in a printing device is not operating, wherein a plurality of print jobs is not printing at the print engine;
processing a print job of the plurality of print jobs at a raster image processing (RIP) system corresponding to a digital front end (DFE) of the printing device;
generating at least one rendered page for the print job by a first renderer of the RIP system;
allocating a second renderer of the RIP system to a secondary job at the printing device; and
processing the secondary job with the second renderer of the RIP system.

2. The method of claim 1, further comprising storing the at least one rendered page at a first data storage accessible by the DFE.

3. The method of claim 2, further comprising determining that a storage threshold is reached for the first data storage.

4. The method of claim 3, further comprising storing the at least one rendered page at a second data storage accessible by the DFE.

5. The method of claim 1, further comprising determining that the at least one rendered page is a complex page.

6. The method of claim 5, further comprising storing the at least one rendered page at a hard disk storage accessible by the DFE.

7. The method of claim 1, wherein the secondary job is an ink estimation job.

8. The method of claim 1, further comprising releasing the renderer from processing the at least one page of the print job to allocate to the secondary job.

9. The method of claim 1, further comprising re-allocating the renderer back to processing the print job when the print engine is printing.

10. A method for managing printing operations, the method comprising:
detecting that a print engine in a printing device is not operating, wherein a plurality of print jobs is not printing at the print engine;
processing a print job of the plurality of print jobs at a raster image processing (RIP) system corresponding to a digital front end (DFE) of the printing device;
determining that a storage threshold for a first data storage configured to receive rendered pages from the RIP system is reached, wherein the first data storage is accessible by the DFE of the printing device;
allocating a first renderer of the RIP system to process at least one page of the print job, wherein the at least one page is a complex page; and
allocating a second renderer of the RIP system to process a secondary job received at the DFE.

11. The method of claim 10, wherein the secondary job is an ink estimation job.

12. The method of claim 10, further comprising storing the at least one rendered page at a second data storage accessible by the DFE.

13. The method of claim 12, wherein the second data storage is a hard disk storage accessible by the DFE.

14. The method of claim 10, further comprising releasing the renderer from processing the at least one page of the print job to allocate to the secondary job.

15. The method of claim 10, further comprising re-allocating the renderer back to processing the print job when the print engine is printing.

16. A printing system comprising:
a processor;
a memory coupled to the processor, the memory storing instructions that, when executed on the processor, configures the printing system to perform the operations of
detecting that a print engine in a printing device of the printing system is not operating, wherein a plurality of print jobs is not printing at the print engine;
processing a print job of the plurality of print jobs at a raster image processing (RIP) system corresponding to a digital front end (DFE) of the printing device;
generating at least one rendered page for the print job by a first renderer of the RIP system;
allocating a second renderer of the RIP system to a secondary job at the printing device; and
processing the secondary job with the second renderer of the RIP system.

17. The printing system of claim 16, wherein the operations further include storing the at least one rendered page at a first data storage accessible by the DFE.

18. The printing system of claim 17, wherein the operations further include determining that a storage threshold is reached for the first data storage.

19. The printing system of claim 18, wherein the operations further include storing the at least one rendered page at a second data storage accessible by the DFE.

20. The printing system of claim 18, wherein the operations further include determining that the at least one rendered page is a complex page.
